(19) United States
(12) Patent Application Publication
(10) Pub. No.: US 2024/0202547 A1
(43) Pub. Date: Jun. 20, 2024

(54) ABDUCTIVE REASONING APPARATUS, ABDUCTIVE REASONING METHOD, AND STORAGE MEDIUM

(71) Applicant: NEC Corporation, Minato-ku, Tokyo (JP)

(72) Inventor: Kazeto YAMAMOTO, Tokyo (JP)

(73) Assignee: NEC Corporation, Minato-ku, Tokyo (JP)

(21) Appl. No.: 18/286,386

(22) PCT Filed: Apr. 16, 2021
(86) PCT No.: PCT/JP2021/015727

§ 371 Date: Oct. 11, 2023

(51) Int. Cl. G06N 5/022

(52) U.S. Cl. CPC G06N 5/022

(57) ABSTRACT

An abductive reasoning apparatus (10) includes: a generation section (12) that generates a plurality of hypotheses with reference to background knowledge information and query information; a construction section (13) that constructs a constraint set by listing some of a plurality of logical constraints to be satisfied between a plurality of elements constituting each of the plurality of hypotheses; a retrieval section (14) that retrieves any one of the plurality of hypotheses as a candidate solution hypothesis with reference to the constraint set; a determination section (15) that determines whether the candidate solution hypothesis satisfies a logical constraint which is among logical constraints to be satisfied between elements constituting the candidate solution hypothesis and which is not included in the constraint set; and an output section (16) that outputs the candidate solution hypothesis as a solution hypothesis in a case where the candidate solution hypothesis satisfies the logical constraint.

### TECHNICAL FIELD

The present invention relates to an abductive reasoning technique.

### BACKGROUND ART

Abductive reasoning (abduction) is a reasoning method in which a query logical formula (query) representing an observation and background knowledge are received and a logical formula representing the best hypothesis is output on the basis of a predetermined evaluation function. Note here that the predetermined evaluation function is a function (evaluation function) that represents goodness of each candidate hypothesis in a real value. Note also that the logical formula representing the best hypothesis is the best logical formula (best hypothesis, solution hypothesis) among logical formulas (hypotheses) that are consistent with background knowledge and that allow the query logical formula representing an observation to be derived in a deductive manner.

Non-Patent Literature 1 discloses a method for implementing abductive reasoning on a computer. Non-Patent Literature 2 discloses, as extension of the method disclosed in Non-Patent Literature 1, a method for efficiently carrying out computation by sequentially considering logical constraints.

### CITATION LIST

### Non-Patent Literature

### [Non-patent Literature 1]

Naoya Inoue and Kentaro Inui. ILP-based Reasoning for Weighted Abduction. In Proceedings of AAAI Workshop on Plan, Activity and Intent Recognition, pp. 25-32, August 2011.

### [Non-patent Literature 2]

Naoya Inoue and Kentaro Inui. Large-scale Cost-based Abduction in Full-fledged First-order Predicate Logic with Cutting Plane Inference. In Proceedings of the 13th European Conference on Logics in Artificial Intelligence, pp. 281-293, September 2012.

### SUMMARY OF INVENTION

### Technical Problem

The techniques according to Non-Patent Literature 1 and Non-Patent Literature 2 each employ a procedure in which logical constraints necessary for reasoning are all listed and then a solution hypothesis is determined by giving the logical constraints to a mathematical optimization solver. Thus, a case where a huge number of logical constraints are to be considered causes the following problem: since a process for listing the logical constraints requires a longer computation time, the process serves as a bottleneck, so that reasoning time as a whole accordingly increases.

An example aspect of the present invention has been made in view of the above problems, and an example object thereof is to provide a technique for improving computation efficiency in generation of a solution hypothesis in abductive reasoning.

### Solution to Problem

An abductive reasoning apparatus according to an example aspect of the present invention includes: an acquisition means that acquires background knowledge information which represents background knowledge by at least one logical formula and query information which represents an observed fact by at least one logical formula; a generation means that generates a plurality of hypotheses with reference to the background knowledge information and the query information; a construction means that constructs a constraint set by listing some of a plurality of logical constraints to be satisfied between a plurality of elements constituting each of the plurality of hypotheses; a retrieval means that retrieves any one of the plurality of hypotheses as a candidate solution hypothesis with reference to the constraint set; a determination means that determines whether the candidate solution hypothesis satisfies a logical constraint which is among logical constraints to be satisfied between elements constituting the candidate solution hypothesis and which is not included in the constraint set; and an output means that outputs the candidate solution hypothesis as a solution hypothesis in a case where the candidate solution hypothesis satisfies the logical constraint which is not included in the constraint set.

An abductive reasoning method according to an example aspect of the present invention includes: (a) acquiring background knowledge information which represents background knowledge by at least one logical formula and query information which represents an observed fact by at least one logical formula; (b) generating a plurality of hypotheses with reference to the background knowledge information and the query information; (c) constructing a constraint set by listing some of a plurality of logical constraints to be satisfied between a plurality of elements constituting each of the plurality of hypotheses; (d) retrieving any one of the plurality of hypotheses as a candidate solution hypothesis with reference to the constraint set; (e) determining whether the candidate solution hypothesis satisfies a logical constraint which is among logical constraints to be satisfied between elements constituting the candidate solution hypothesis and which is not included in the constraint set; and (f) outputting the candidate solution hypothesis as a solution hypothesis in a case where the candidate solution hypothesis satisfies the logical constraint which is not included in the constraint set, (a) to (f) being carried out by an abductive reasoning apparatus.

A program according to an example aspect of the present invention is a program for causing a computer to function as an abductive reasoning apparatus, the program causing the computer to function as: an acquisition means that acquires background knowledge information which represents background knowledge by at least one logical formula and query information which represents an observed fact by at least one logical formula; a generation means that generates a plurality of hypotheses with reference to the background knowledge information and the query information; a construction means that constructs a constraint set by listing some of a plurality of logical constraints to be satisfied between a plurality of elements constituting each of the plurality of hypotheses; a retrieval means that retrieves any one of the plurality of hypotheses as a candidate solution hypothesis with reference to the constraint set; a determination means that determines whether the candidate solution hypothesis satisfies a logical constraint which is among logical constraints to be satisfied between elements constituting the candidate solution hypothesis and which is not included in the constraint set; and an output means that outputs the candidate solution hypothesis as a solution hypothesis in a case where the candidate solution hypothesis satisfies the logical constraint which is not included in the constraint set.

### Advantageous Effects of Invention

An example aspect of the present invention makes it possible to improve computation efficiency in generation of a solution hypothesis in abductive reasoning.

### BRIEF DESCRIPTION OF DRAWINGS

FIG. 1 is a block diagram illustrating a configuration of an abductive reasoning apparatus according to a first example embodiment of the present invention.

FIG. 2 is a flowchart illustrating a flow of an abductive reasoning method according to the first example embodiment of the present invention.

FIG. 3 is a block diagram illustrating a configuration of an abductive reasoning apparatus according to a second example embodiment of the present invention.

FIG. 4 is a flowchart illustrating a flow of an abductive reasoning method according to the second example embodiment of the present invention.

FIG. 5 is a diagram illustrating an example of a logical constraint to be considered in reasoning, including an order relation, according to the second example embodiment of the present invention.

FIG. 6 is a diagram schematically illustrating a relationship between a hypothesis and a logical constraint according to the second example embodiment of the present invention.

FIG. 7 is a block diagram illustrating an example of a hardware configuration of the abductive reasoning apparatus according to each of the example embodiments of the present invention.

### EXAMPLE EMBODIMENTS

### First Example Embodiment

A first example embodiment of the present invention will be described in detail with reference to the drawings. The present example embodiment is an embodiment serving as a basis for example embodiments described later.

### (Configuration of Abductive Reasoning Apparatus)

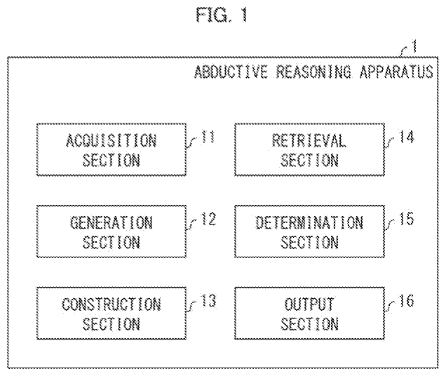

A configuration of an abductive reasoning apparatus 1 according to the present example embodiment will be described with reference to FIG. 1. FIG. 1 is a block diagram illustrating the configuration of the abductive reasoning apparatus 1. The abductive reasoning apparatus 1 is an apparatus for generating a hypothesis by abductive reasoning. The abductive reasoning apparatus 1 includes an acquisition section 11, a generation section 12, a construction section 13, a retrieval section 14, a determination section 15, and an output section 16.

### (Acquisition Section)

The acquisition section 11 acquires background knowledge information which represents background knowledge by at least one logical formula and query information which represents an observed fact by at least one logical formula. The background knowledge information is information which represents, by at least one logical formula, a set of rules (background knowledge) that a consequent holds when an antecedent holds. The background knowledge is sometimes called reasoning knowledge. The query information is information which represents an observed fact by at least one logical formula.

The acquisition section 11 may acquire the background knowledge information and/or the query information by reading the background knowledge information and/or the query information from a storage apparatus included in the abductive reasoning apparatus 1, or from an external storage apparatus. Alternatively, the acquisition section 11 may acquire the background knowledge information and/or the query information by receiving the background knowledge information and/or the query information from another apparatus via a communication section. Further alternatively, the acquisition section 11 may generate the background knowledge information and/or the query information in response to an input operation carried out by a user via any input apparatus such as a mouse or a touch panel, and acquire the piece(s) of information thus generated.

### (Generation Section)

The generation section 12 generates a plurality of hypotheses with reference to the background knowledge information and the query information. The hypothesis is represented by a logical formula as in the case of the background knowledge information and the query information. To a specific method for generating a plurality of hypotheses with use of the background knowledge information and the query information, it is possible to apply various methods such as weighted abductive reasoning as disclosed in, for example, Kazeto Yamamoto et. al., “Backpropagation Learning for Weighted Abduction”, IPSJ SIG Technical Report, Vol. 2012-NL-206, No. 9/Vol. 2012-SLP-91, No. 9, 2012.

### (Construction Section)

The construction section 13 constructs a constraint set by listing some of a plurality of logical constraints to be satisfied between a plurality of elements constituting each of the plurality of hypotheses. A logical constraint is a constraint to be satisfied so that a hypothesis is consistent with background knowledge. The logical constraint is classified into a plurality of types. The construction section 13 lists some of a plurality of types of logical constraints.

The construction section 13 lists logical constraints that are among logical constraints to be satisfied by the plurality of hypotheses generated by the generation section 12 and that are not to be subjected to determination by the determination section 15 (described later). The logical constraints that are listed by the construction section 13 are, for example, constraints each of which satisfies a condition that a combination of logical formulas such as those deriving inconsistencies must not be present in a solution hypothesis. Furthermore, the logical constraints are, for example, constraints each of which satisfies a condition that a solution hypothesis must be able to derive an observation in a deductive manner. For example, the construction section 13 lists, by the method disclosed in Non-Patent Literature 1 or Non-Patent Literature 2, logical constraints that are not to be subjected to determination by the determination section 15. Note that a method in which the construction section 13 lists the logical constraints is not limited to the above-described method. The construction section 13A may list the logical constraints by another method.

### (Retrieval Section)

The retrieval section 14 retrieves any one of the plurality of hypotheses, which have been generated by the generation section 12, as a candidate solution hypothesis with reference to the constraint set. In other words, the retrieval section 14 retrieves the candidate solution hypothesis from among a plurality of hypotheses under the logical constraints listed by the construction section 13. For example, the retrieval section 14 represents the constraint set as an integer linear programming problem and then uses an arbitrary solver for the integer linear programming problem to retrieve the candidate solution hypothesis. Note that the retrieval section 14 may use another method to retrieve the candidate solution hypothesis.

### (Determination Section)

The determination section 15 determines whether the candidate solution hypothesis satisfies a logical constraint which is among logical constraints to be satisfied between elements constituting the candidate solution hypothesis and which is not included in the constraint set constructed by the construction section 13. For example, the determination section 15 generates, on the basis of the elements constituting the candidate solution hypothesis, a logical constraint to be subjected to determination, and determines whether the candidate solution hypothesis satisfies the generated logical constraint. For example, the determination section 15 lists, by the method disclosed in Non-Patent Literature 1 or Non-Patent Literature 2, logical constraints that are to be subjected to determination by the determination section 15. Note that a method in which the determination section 15 lists the logical constraints is not limited to the above-described method. The determination section 15 may alternatively use another method to list the logical constraints to be subjected to determination.

### (Output Section)

The output section 16 outputs the candidate solution hypothesis as a solution hypothesis in a case where the candidate solution hypothesis satisfies the logical constraint which is not included in the constraint set. For example, the output section 16 may display the solution hypothesis on a display panel or store the solution hypothesis in a storage medium (not illustrated). Alternatively, for example, the output section 16 may output the solution hypothesis to another apparatus via an input/output interface or a communication interface.

As described above, a configuration is employed such that the abductive reasoning apparatus 1 according to the present example embodiment includes: the acquisition section 11 that acquires background knowledge information which represents background knowledge by at least one logical formula and query information which represents an observed fact by at least one logical formula; the generation section 12 that generates a plurality of hypotheses with reference to the background knowledge information and the query information; the construction section 13 that constructs a constraint set by listing some of a plurality of logical constraints to be satisfied between a plurality of elements constituting each of the plurality of hypotheses; the retrieval section 14 that retrieves any one of the plurality of hypotheses as a candidate solution hypothesis with reference to the constraint set; the determination section 15 that determines whether the candidate solution hypothesis satisfies a logical constraint which is among logical constraints to be satisfied between elements constituting the candidate solution hypothesis and which is not included in the constraint set; and the output section 16 that outputs the candidate solution hypothesis as a solution hypothesis in a case where the candidate solution hypothesis satisfies the logical constraint which is not included in the constraint set.

According to the above configuration, the abductive reasoning apparatus 1 retrieves the candidate solution hypothesis not with reference to all the plurality of logical constraints to be satisfied between the plurality of elements constituting each of the plurality of hypotheses, but with reference to some of the plurality of logical constraints. With this, as compared with a case where the solution hypothesis is retrieved with reference to all the plurality of logical constraints, it is possible to further improve computation efficiency in generation of a solution hypothesis.

### (Flow of Abductive Reasoning Method)

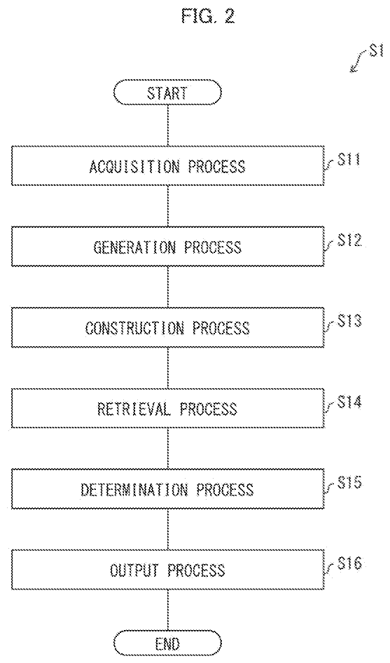

A flow of an abductive reasoning method according to the present example embodiment will be described with reference to FIG. 2. FIG. 2 is a flowchart illustrating the flow of the abductive reasoning method. The abductive reasoning method according to the present example embodiment at least includes steps S11 to S16 as illustrated in FIG. 2.

In the step S11, the acquisition section 11 acquires background knowledge information which represents background knowledge by at least one logical formula and query information which represents an observed fact by at least one logical formula. In the step S12, the generation section 12 generates a plurality of hypotheses with reference to the background knowledge information and the query information. In the step S13, the construction section 13 constructs a constraint set by listing some of a plurality of logical constraints to be satisfied between a plurality of elements constituting each of the plurality of hypotheses. In the step S14, the retrieval section 14 retrieves any one of the plurality of hypotheses as a candidate solution hypothesis with reference to the constraint set.

In the step S15, the determination section 15 determines whether the candidate solution hypothesis satisfies a logical constraint which is among logical constraints to be satisfied between elements constituting the candidate solution hypothesis and which is not included in the constraint set. In the step S16, the output section 16 outputs the candidate solution hypothesis as a solution hypothesis in a case where the candidate solution hypothesis satisfies the logical constraint which is not included in the constraint set.

The abductive reasoning method according to the present example embodiment brings about an effect of making it possible to improve computation efficiency in generation of a solution hypothesis in abductive reasoning. Note that in a case where the functions of the acquisition section 11, the generation section 12, the construction section 13, the retrieval section 14, the determination section 15, and the output section 16 are realized by at least one processor, it can be expressed that the process in S11 to S16 is carried out by the at least one processor.

### Second Example Embodiment

The following description will discuss a second example embodiment of the present invention in detail with reference to the drawings. Note that members having functions identical to those of the respective members described in the first example embodiment are given respective identical reference numerals, and a description of those members is omitted as appropriate.

### (Configuration of Abductive Reasoning Apparatus)

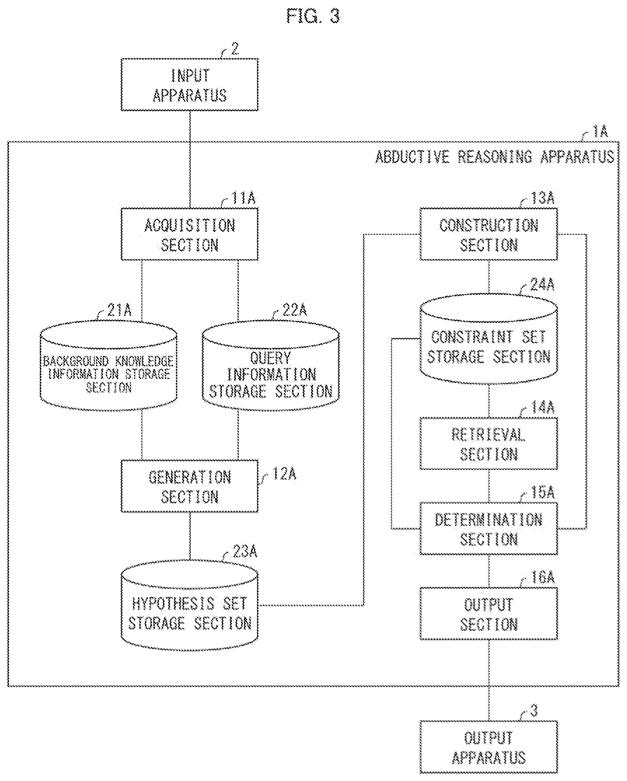

A configuration of an abductive reasoning apparatus 1A according to the present example embodiment will be described with reference to FIG. 3. FIG. 3 is a block diagram illustrating the configuration of the abductive reasoning apparatus 1A. The abductive reasoning apparatus 1A is an apparatus that generates a hypothesis by abductive reasoning as in the case of the abductive reasoning apparatus 1 according to the first example embodiment. FIG. 3 illustrates not only the abductive reasoning apparatus 1A but also an input apparatus 2 that inputs background knowledge information and query information to the abductive reasoning apparatus 1A and an output apparatus 3 that is a destination to which information output by the abductive reasoning apparatus 1A is output.

The abductive reasoning apparatus 1A includes an acquisition section 11A, a generation section 12A, a construction section 13A, a retrieval section 14A, a determination section 15A, and an output section 16A. The abductive reasoning apparatus 1A also includes a background knowledge information storage section 21A, a query information storage section 22A, a hypothesis set storage section 23A, and a constraint set storage section 24A.

The acquisition section 11A acquires the background knowledge information and the query information as in the case of the acquisition section 11 according to the first example embodiment. For example, the acquisition section 11A acquires the background knowledge information input by the input apparatus 2 and the query information input by the input apparatus 2, and stores the background knowledge and the query information in the background knowledge information storage section 21A and the query information storage section 22A, respectively.

The generation section 12A generates a plurality of hypotheses with reference to the background knowledge information and the query information as in the case of the generation section 12 according to the first example embodiment. The generation section 12A stores the generated plurality of hypotheses in the hypothesis set storage section 23A.

As in the case of the construction section 13 according to the first example embodiment, the construction section 13A constructs a constraint set by listing some of a plurality of logical constraints to be satisfied between a plurality of elements constituting each of the plurality of hypotheses. The construction section 13A stores the constructed constraint set in the constraint set storage section 24A.

The retrieval section 14A retrieves any one of the plurality of hypotheses as a candidate solution hypothesis with reference to the constraint set as in the case of the retrieval section 14 according to the first example embodiment. The retrieval section 14A supplies, to the determination section 15A, the candidate solution hypothesis thus retrieved.

The determination section 15A determines, as in the case of the determination section 15 according to the first example embodiment, whether the candidate solution hypothesis retrieved by the retrieval section 14A satisfies a logical constraint which is among logical constraints to be satisfied between elements constituting the candidate solution hypothesis and which is not included in the constraint set.

As in the case of the output section 16 according to the first example embodiment, the output section 16 outputs the candidate solution hypothesis as a solution hypothesis in a case where the candidate solution hypothesis satisfies the logical constraint which is not included in the constraint set. For example, the output section 16 outputs the solution hypothesis to the output apparatus 3.

An input apparatus 2 is, for example, an input apparatus such as a mouse or a touch panel. Alternatively, the input apparatus 2 may be an apparatus that is connected to the abductive reasoning apparatus 1 via an input/output interface or a communication interface. The output apparatus is, for example, a display apparatus including a display panel, an external storage apparatus, or a printing apparatus. Alternatively, the output apparatus may be, for example, an apparatus that is connected to the abductive reasoning apparatus 1 via an input/output interface or a communication interface.

### (Flow of Abductive Reasoning Method)

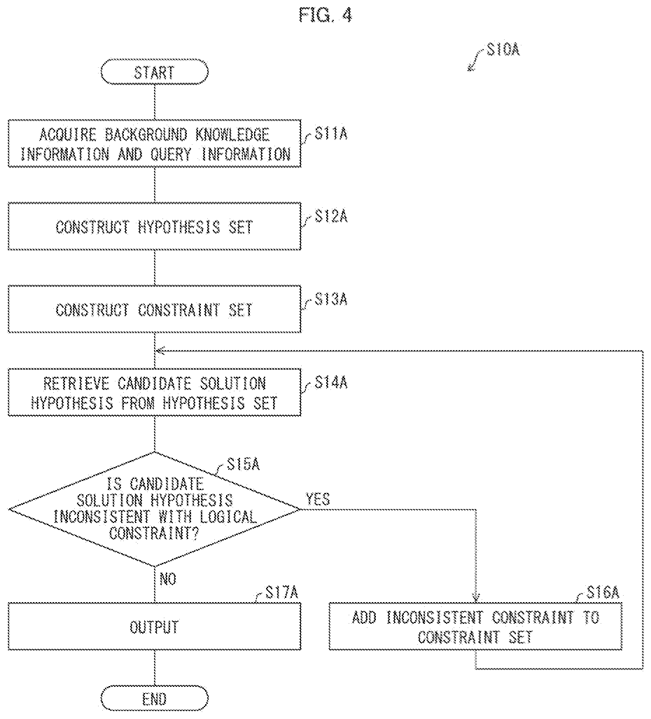

FIG. 4 is a flowchart illustrating a flow of an abductive reasoning method S10A according to the present embodiment. In a step S11A, the acquisition section 11A acquires background knowledge information D1 and query information D2. For example, the acquisition section 11A acquires the background knowledge information D1 and the query information D2 from the input apparatus 2.

In a step S12A, the generation section 12A constructs a hypothesis set D3 by sequentially generating a plurality of hypotheses from the background knowledge information D1 and the query information D2. A method in which the generation section 12A generates the plurality of hypotheses is similar to the method in which the generation section 12 according to the above-described first example embodiment generates the plurality of hypotheses.

In a step S13A, the construction section 13A constructs a constraint set D4 by listing, among logical constraints to be satisfied by the hypotheses included in the hypothesis set D3, logical constraints that are not to be subjected to determination by the determination section 15A. In other words, assuming that a logical constraint that occurs for each combination of the plurality of elements constituting each of the plurality of hypotheses generated by the generation section 12A is to be subjected to determination by the determination section 15A, the construction section 13A constructs the constraint set by listing logical constraints which are among the plurality of logical constraints and which are not to be subjected to determination.

In the present example embodiment, examples of the logical constraints to be satisfied by the hypotheses include the following four types of logical constraints (i) to (iv). Note that the logical constraints according to the present example embodiment are not limited to these types of logical constraints, but may include other types of logical constraints.
(i) a transitive law for an equivalence relation
(ii) a transitive law, an asymmetric law, and an antireflexive law for a term
(iii) a constraint for a hypothesis being consistent with the background knowledge information D1
(iv) a constraint that a hypothesis must be able to derive an observation in a deductive manner

(i) The transitive law for an equivalence relation is a constraint that a relationship represented by the following expression (1) must be established among arbitrary logical variables x, y, and z.

$$( x = y ) \hat{} ( y = z ) = > ( x = z ) \qquad ( 1 )$$

(ii) The transitive law, the asymmetric law, and the antireflexive law for a term are a constraint that the following expressions (2) to (4) must hold for a logical formula having a term in which these laws hold for an argument. In the following expressions (2) to (4), seq, which is an example of such a term, is a term representing a temporal before-and-after relationship.

$$seq ( x , y ) \hat{} seq ( y , z ) = > seq ( x , z ) \qquad ( 2 )$$

$$seq ( x , y ) = > ! seq ( x , y ) \qquad ( 3 )$$

$$seq ( x , y ) = > ( x != y ) \qquad ( 4 )$$

(iii) The constraint for a hypothesis being inconsistent with the background knowledge information D1 and (iv) the constraint that a hypothesis must be able to derive an observation in a deductive manner are represented by respective expressions (5) and (6) below. In the expressions (5) and (6), B is background knowledge included in the background knowledge information D1, H is a hypothesis included in the hypothesis set D3, and O is information included in the query information D2 and indicative of an observation.

$$B ⋃ H \vert \neq ⊥ \qquad ( 5 )$$

$$B ⋃ H \vert = O \qquad ( 6 )$$

The logical constraint that is to be subjected to determination by the determination section 15A includes, for example, a logical constraint on an equivalence relation between a plurality of elements. Furthermore, the logical constraint that is to be subjected to determination by the determination section 15A includes, for example, a logical constraint on an order relation between a plurality of elements. The logical constraint that is to be subjected to determination by the determination section 15A is hereinafter also referred to as a “first logical constraint”. Examples of the logical constraint that is to be subjected to determination by the determination section 15A include (i) the transitive law for an equivalence relation and (ii) the transitive law, the asymmetric law, and the antireflexive law for a term.

In contrast, examples of the logical constraints that are listed by the construction section 13A include constraints excluding (i) the transitive law for an equivalence relation and (ii) the transitive law, the asymmetric law, and the antireflexive law for a term. In the following description, the logical constraints that are listed by the construction section 13A are hereinafter also referred to as “second logical constraints”. Examples of the second logical constraints that are listed by the construction section 13A include (iii) the constraint for a hypothesis being consistent with the background knowledge information D1 and (iv) the constraint that a hypothesis must be able to derive an observation in a deductive manner. A method that is used by the construction section 13A to list the second logical constraints may be, for example, the method disclosed in Non-Patent Literature 1 or Non-Patent Literature 2. Note that the method in which the construction section 13A lists the logical constraints is not limited to this, and the construction section 13A may use another method.

The first logical constraint (logical constraint subjected to determination by the determination section 15) is, for example, a constraint of a type such that a greater number of elements result in a more huge number of combinations. Logical constraints on, for example, the transitive law for an equivalence relation and a term representing an order relation, the transitive law and the term each being the first logical constraint, have the following feature: a huge number of combinations are to be considered as logical constraints, whereas only some of the logical constraints are necessary for actually obtaining a solution hypothesis. In contrast, the second logical constraints (logical constraints used by the retrieval section 14) are, for example, logical constraints whose number of combinations is not so huge as compared with the first logical constraint.

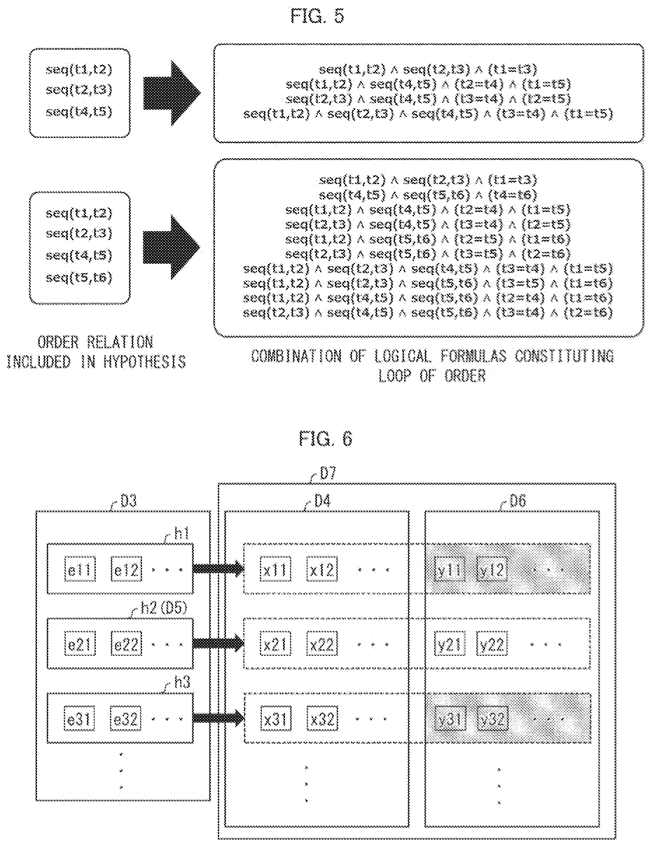

FIG. 5 is a diagram illustrating a specific example of (i) an order relation between elements included in a hypothesis and (ii) a combination of logical formulas constituting a loop of order. In view of reasoning including a term seq(t1,t2) that represents the temporal before-and-after relationship, the transitive law, the asymmetric law, and the antireflexive law hold for this term. In hypothetical reasoning, the number of combinations of logical formulas in which a temporal order represented by this term causes a loop, that is, which are inconsistent with the asymmetric law increases exponentially in accordance with the number of logical formulas having this term, as illustrated in FIG. 5.

In a step S14A in FIG. 4, the retrieval section 14A retrieves a candidate solution hypothesis D5 from the hypothesis set D3 under the constraint set D4. The candidate solution hypothesis is hereinafter also referred to as a “candidate for a solution hypothesis”. For example, the retrieval section 14A represents the constraint set D4 as an integer linear programming problem and then uses an arbitrary solver for the integer linear programming problem to retrieve the candidate solution hypothesis. Note that the retrieval section 14A may use another method to retrieve the candidate solution hypothesis.

In a step S15A, the determination section 15A determines whether the candidate solution hypothesis D5 is inconsistent with the first logical constraint. For example, on the basis of elements constituting the candidate solution hypothesis D5, the determination section 15A lists first logical constraints including (i) the transitive law for an equivalence relation and (ii) the transitive law, the asymmetric law, and the antireflexive law for a term, and determines whether the candidate solution hypothesis D5 is inconsistent with the listed first logical constraints.

In a case where the first logical constraints listed by the determination section 15A include a first logical constraint that is inconsistent with the candidate solution hypothesis D5 (YES in the step S15), the determination section 15A proceeds to the process in a step S16A. In contrast, in a case where there is no first logical constraint that is inconsistent with the candidate solution hypothesis D5 (NO in the step S15A), the determination section 15A proceeds to the process in a step S17A.

In the step S16A, the determination section 15A adds, to the constraint set D4, the first logical constraint that is inconsistent with the candidate solution hypothesis D5. After the determination section 15A ends the process in the step S16A, the process returns to the step S14A, and the retrieval section 14A retrieves the candidate solution hypothesis D5 again. In other words, in the step S15A to the step S14A, in a case where the candidate solution hypothesis D5 does not satisfy a first logical constraint that is not included in the constraint set D4, the determination section 15A adds the first logical constraint to the constraint set D4 and causes the retrieval section 14A to function again. The abductive reasoning apparatus 1A repeatedly carries out the step S14A to the step S16A until a solution hypothesis that is consistent with logical constraints is obtained.

In the step S14A, the retrieval section 14A may exclude the candidate solution hypothesis that does not satisfy the first logical constraint which is not included in the constraint set D4, and retrieve a new candidate solution hypothesis with reference to the constraint set D4.

In a step S17A, the output section 16A outputs the candidate solution hypothesis D5 as a solution hypothesis. For example, the output section 16A outputs the solution hypothesis to the output apparatus 3.

FIG. 6 is a diagram schematically illustrating a relationship between a hypothesis and a logical constraint. In the example of FIG. 6, the hypothesis set D3 includes hypotheses h1, h2, h3, . . . . A constraint set D7 is a set of logical constraints on which the hypotheses included in the hypothesis set D3 are to be dependent, and includes the constraint set D4. The constraint set D4 is a set constructed by the construction section 13A, that is, a set of the second logical constraints.

Logical constraints x11, x12, . . . , y11, y12, . . . are logical constraints to be satisfied between elements constituting the hypothesis h1. Logical constraints x21, x22, . . . , y21, y22, . . . are logical constraints to be satisfied between elements constituting the hypothesis h2. Logical constraints x31, x32, . . . y31, y32, . . . are logical constraints to be satisfied between elements constituting the hypothesis h3. In order to facilitate understanding of the description, FIG. 6 illustrates a case where the logical constraints included in the constraint set D7 each correspond to one of the hypotheses. Note, however, that some or all of the logical constraints included in the constraint set D7 may correspond to two or more of the hypotheses.

In this example, in a case where the retrieval section 14A specifies the hypothesis h2 as the candidate solution hypothesis D5, the determination section 15A lists the first logical constraints y21, y22, . . . to be satisfied between two or more of the elements e21, e22, . . . constituting the hypothesis h2, and carries out determination. That is, the determination section 15A does not list the first logical constraints y11, y12 . . . y31, y32, . . . that are included in a set D6 (illustrated in FIG. 6) of the first logical constraints and that are related to the other hypotheses h1, h3, . . . which are not the candidate solution hypothesis D5.

Note that in Non-Patent Literature 1 and Non-Patent Literature 2, abductive reasoning has been carried out by the following method. First, candidate solution hypotheses (candidate hypotheses) are listed from a query logical formula and background knowledge. Next, in the method, from among the listed candidate solution hypotheses, a problem for retrieving the best solution hypothesis is equivalently transformed as a constrained combinational optimization problem such as an integer linear programming problem. Then, in the method, the optimization problem thus obtained by transformation is solved with use of an external solver so that the best solution hypothesis is obtained.

The method disclosed in Non-Patent Literature 2 is carried out as follows: The best solution hypothesis is retrieved by giving, to a solver, not all constraints but only some of logical constraints. It is determined whether a resulting solution hypothesis satisfies the remaining constraints. In a case where the resulting solution hypothesis is inconsistent with any one of the logical constraints, the logical constraint with which the resulting solution hypothesis is inconsistent is added to the solver, and then the best solution hypothesis is retrieved again. It is argued in Non-Patent Literature 2 that employment of such a procedure makes it possible to efficiently retrieve the best solution hypothesis.

However, both the methods disclosed in Non-Patent Literature 1 and Non-Patent Literature 2 assume that all logical constraints to be considered are listed first. In other words, the method disclosed in Non-Patent Literature 2 requires that all the second logical constraints (constraint set D4) and the first logical constraints (set D6) illustrated in FIG. 6 be listed first. Thus, a case where a huge number of logical constraints are to be considered originally causes a problem of a significant decrease in computation speed with a process for listing the logical constraints serving as a bottleneck. In order to obtain a consistent hypothesis, it is necessary to define logical constraints so that none of these combinations occur. As a result, the number of logical constraints to be considered accordingly increases exponentially. This causes a problem such that the process for listing the logical constraints requires a longer computation time.

Typical examples of causing such a situation include reasoning involving a term that is for representing a so-called order relation and that satisfies the transitive law and the asymmetric law. A retrieval space that includes more logical formulas having such a term accordingly results in an exponential increase in number of necessary logical constraints. This makes it practically impossible in many cases to obtain a solution hypothesis.

In contrast, according to the present example embodiment, with respect to a candidate solution hypothesis obtained by listing some types of logical constraints instead of listing all the logical constraints in advance, the abductive reasoning apparatus 1A carries out determination with use of the remaining types of logical constraints. In the example of FIG. 6, with respect to the candidate solution hypothesis D5 obtained by listing the second logical constraints (constraint set D4), the abductive reasoning apparatus 1A carries out determination with use of y21 and y22, which are the remaining types of the first logical constraints. With this, a retrieval process can be carried out with the retrieval space reduced. This makes it possible to improve computation efficiency in generation of a solution hypothesis in abductive reasoning.

According to the present example embodiment, in a case where a candidate solution hypothesis retrieved by the retrieval section 14A does not satisfy a first logical constraint, the abductive reasoning apparatus 1A adds the first logical constraint to the constraint set D4 and causes the retrieval section 14A to function again. With this, as compared with a case where all logical constraints are listed in advance, it is possible to further improve computation efficiency in generation of a solution hypothesis in abductive reasoning.

Furthermore, according to the present example embodiment, the abductive reasoning apparatus 1A excludes the candidate solution hypothesis that does not satisfy the first logical constraint which is not included in the constraint set D4, and retrieves a new candidate solution hypothesis with reference to the constraint set D4. This makes it possible to improve computation efficiency in generation of a solution hypothesis in abductive reasoning.

### Software Implementation Example

Some or all of the functions of the abductive reasoning apparatuses 1 and 1A may be realized by hardware such as an integrated circuit (IC chip) or may be alternatively realized by software.

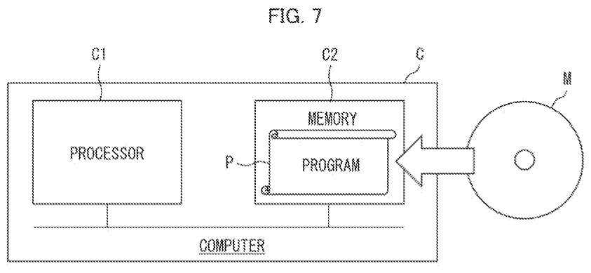

In the latter case, each of the abductive reasoning apparatuses 1 and 1A is realized by, for example, a computer that executes instructions of a program that is software realizing the functions. FIG. 7 illustrates an example of such a computer (hereinafter referred to as “computer C”). The computer C includes at least one processor C1 and at least one memory C2. The memory C2 stores a program P for causing the computer C to operate as each of the abductive reasoning apparatuses 1 and 1A. In the computer C, the functions of the abductive reasoning apparatuses 1 and 1A are realized by the processor C1 reading the program P from the memory C2 and executing the program P.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via the transmission medium.

The sections of the abductive reasoning apparatuses 1 and 1A (the acquisition sections 11 and 11A, the generation sections 12 and 12A, the construction sections 13 and 13A, the retrieval sections 14 and 14A, the determination sections 15 and 15A, and the output sections 16 and 16A) each may be realized by dedicated hardware. Some or all of the components of the abductive reasoning apparatuses 1 and 1A may be realized by general-purpose or dedicated circuitry, a general-purpose or dedicated processor, or the like, or a combination thereof. The general-purpose or dedicated circuitry, the general-purpose or dedicated processor, or the like may be constituted by a single chip or alternatively by a plurality of chips that are connected to each other via a bus. Some or all of the components of the abductive reasoning apparatuses 1 and 1A may be realized by a combination of a program and the above-described circuitry and/or the like.

In a case where some or all of the components of the abductive reasoning apparatuses 1 and 1A are realized by a plurality of information processing apparatuses, circuitry, and/or the like, the plurality of information processing apparatuses, the circuitry, and/or the like may be disposed in a concentrated manner or in a distributed manner. For example, the information processing apparatuses, the circuitry, and/or the like may be realized in a manner of being connected via a communication network, i.e., in the form of a client server system, a cloud computing system, and/or the like. The functions of the abductive reasoning apparatuses 1 and 1A may be provided in software-as-a-service (SaaS) form.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following supplementary notes.

### (Supplementary Note 1)

An abductive reasoning apparatus including:
an acquisition means that acquires background knowledge information which represents background knowledge by at least one logical formula and query information which represents an observed fact by at least one logical formula;
a generation means that generates a plurality of hypotheses with reference to the background knowledge information and the query information;
a construction means that constructs a constraint set by listing some of a plurality of logical constraints to be satisfied between a plurality of elements constituting each of the plurality of hypotheses;
a retrieval means that retrieves any one of the plurality of hypotheses as a candidate solution hypothesis with reference to the constraint set;
a determination means that determines whether the candidate solution hypothesis satisfies a logical constraint which is among logical constraints to be satisfied between elements constituting the candidate solution hypothesis and which is not included in the constraint set; and
an output means that outputs the candidate solution hypothesis as a solution hypothesis in a case where the candidate solution hypothesis satisfies the logical constraint which is not included in the constraint set.

The above configuration makes it possible to improve computation efficiency in generation of a solution hypothesis in abductive reasoning.

### (Supplementary Note 2)

The abductive reasoning apparatus according to Supplementary note 1, wherein
in a case where the candidate solution hypothesis does not satisfy the logical constraint which is not included in the constraint set, the determination means adds the logical constraint to the constraint set and causes the retrieval means to function again.

According to the above configuration, the candidate solution hypothesis can be retrieved again in a case where the candidate solution hypothesis does not satisfy the logical constraint which is not included in the constraint set.

### (Supplementary Note 3)

The abductive reasoning apparatus according to Supplementary note 1 or 2, wherein
the retrieval means excludes the candidate solution hypothesis that does not satisfy the logical constraint which is not included in the constraint set, and retrieves a new candidate solution hypothesis with reference to the constraint set.

As compared with a case where the candidate solution hypothesis that does not satisfy the logical constraint which is not included in the logical constraint set is not excluded, the above configuration makes it possible to improve computation efficiency in retrieval of the candidate solution hypothesis

### (Supplementary Note 4)

The abductive reasoning apparatus according to any one of Supplementary notes 1 to 3, wherein
assuming that a logical constraint that occurs for each combination of the plurality of elements constituting each of the plurality of hypotheses is to be subjected to determination, the construction means constructs the constraint set by listing logical constraints which are among the plurality of logical constraints and which are not to be subjected to determination.

The above configuration makes it possible to improve computation efficiency in generation of a solution hypothesis in abductive reasoning.

### (Supplementary Note 5)

The abductive reasoning apparatus according to Supplementary note 4, wherein
the logical constraint that is to be subjected to determination includes a logical constraint on an equivalence relation between the plurality of elements.

The above configuration makes it possible to improve computation efficiency in generation of a solution hypothesis in abductive reasoning.

### (Supplementary Note 6)

The abductive reasoning apparatus according to Supplementary note 4 or 5, wherein
the logical constraint that is to be subjected to determination includes a logical constraint on an order relation between the plurality of elements.

The above configuration makes it possible to improve computation efficiency in generation of a solution hypothesis in abductive reasoning.

### (Supplementary Note 7)

An abductive reasoning method including:
(a) acquiring background knowledge information which represents background knowledge by at least one logical formula and query information which represents an observed fact by at least one logical formula;
(b) generating a plurality of hypotheses with reference to the background knowledge information and the query information;
(c) constructing a constraint set by listing some of a plurality of logical constraints to be satisfied between a plurality of elements constituting each of the plurality of hypotheses;
(d) retrieving any one of the plurality of hypotheses as a candidate solution hypothesis with reference to the constraint set;
(e) determining whether the candidate solution hypothesis satisfies a logical constraint which is among logical constraints to be satisfied between elements constituting the candidate solution hypothesis and which is not included in the constraint set; and
(f) outputting the candidate solution hypothesis as a solution hypothesis in a case where the candidate solution hypothesis satisfies the logical constraint which is not included in the constraint set,
(a) to (f) being carried out by an abductive reasoning apparatus.

### (Supplementary Note 8)

A program for causing a computer to function as an abductive reasoning apparatus, the program causing the computer to function as:
an acquisition means that acquires background knowledge information which represents background knowledge by at least one logical formula and query information which represents an observed fact by at least one logical formula;
a generation means that generates a plurality of hypotheses with reference to the background knowledge information and the query information;
a construction means that constructs a constraint set by listing some of a plurality of logical constraints to be satisfied between a plurality of elements constituting each of the plurality of hypotheses;
a retrieval means that retrieves any one of the plurality of hypotheses as a candidate solution hypothesis with reference to the constraint set;
a determination means that determines whether the candidate solution hypothesis satisfies a logical constraint which is among logical constraints to be satisfied between elements constituting the candidate solution hypothesis and which is not included in the constraint set; and
an output means that outputs the candidate solution hypothesis as a solution hypothesis in a case where the candidate solution hypothesis satisfies the logical constraint which is not included in the constraint set.

### [Additional Remark 3]

The whole or part of the example embodiments disclosed above can also be expressed as follows.

An abductive reasoning apparatus including at least one processor, the at least one processor including:
an acquisition process for acquiring background knowledge information which represents background knowledge by at least one logical formula and query information which represents an observed fact by at least one logical formula;
a generation process for generating a plurality of hypotheses with reference to the background knowledge information and the query information;
a construction process for constructing a constraint set by listing some of a plurality of logical constraints to be satisfied between a plurality of elements constituting each of the plurality of hypotheses;
a retrieval process for retrieving any one of the plurality of hypotheses as a candidate solution hypothesis with reference to the constraint set;
a determination process for determining whether the candidate solution hypothesis satisfies a logical constraint which is among logical constraints to be satisfied between elements constituting the candidate solution hypothesis and which is not included in the constraint set; and
an output process for outputting the candidate solution hypothesis as a solution hypothesis in a case where the candidate solution hypothesis satisfies the logical constraint which is not included in the constraint set.

Note that the abductive reasoning apparatus may further include a memory, which may store a program for causing the at least one processor to carry out the acquisition process, the generation process, the construction process, the retrieval process, the determination process, and the output process. The program may be stored in a non-transitory tangible computer-readable storage medium.

### REFERENCE SIGNS LIST

1, 1A Abductive reasoning apparatus
11, 11A Acquisition section (acquisition means)
12, 12A Generation section (generation means)
13, 13A Construction section (construction means)
14, 14A retrieval section (retrieval means)
15, 15A Determination section (determination means)
16, 16A Output section (output means)
S1, S10A Abductive reasoning method

What is claimed is:

1. An abductive reasoning apparatus comprising at least one processor, the at least one processor carrying out:
an acquisition process for acquiring background knowledge information which represents background knowledge by at least one logical formula and query information which represents an observed fact by at least one logical formula;
a generation means that generates process for generating a plurality of hypotheses with reference to the background knowledge information and the query information;
a construction process for constructing a constraint set by listing some of a plurality of logical constraints to be satisfied between a plurality of elements constituting each of the plurality of hypotheses;
a retrieval process for retrieving any one of the plurality of hypotheses as a candidate solution hypothesis with reference to the constraint set;
a determination process for determining whether the candidate solution hypothesis satisfies a logical constraint which is among logical constraints to be satisfied between elements constituting the candidate solution hypothesis and which is not included in the constraint set; and
an output process for outputting the candidate solution hypothesis as a solution hypothesis in a case where the candidate solution hypothesis satisfies the logical constraint which is not included in the constraint set.

2. The abductive reasoning apparatus according to claim 1, wherein
in a case where the candidate solution hypothesis does not satisfy the logical constraint which is not included in the constraint set, in the determination process, the at least one processor adds the logical constraint to the constraint set and carries out the retrieval process.

3. The abductive reasoning apparatus according to claim 1, wherein
in the retrieval process, the at least one processor excludes the candidate solution hypothesis that does not satisfy the logical constraint which is not included in the constraint set, and retrieves a new candidate solution hypothesis with reference to the constraint set.

4. The abductive reasoning apparatus according to claim 1, wherein
assuming that a logical constraint that occurs for each combination of the plurality of elements constituting each of the plurality of hypotheses is to be subjected to determination, in the construction process, the at least one processor constructs the constraint set by listing logical constraints which are among the plurality of logical constraints and which are not to be subjected to determination.

5. The abductive reasoning apparatus according to claim 4, wherein
the logical constraint that is to be subjected to determination includes a logical constraint on an equivalence relation between the plurality of elements.

6. The abductive reasoning apparatus according to claim 4, wherein
the logical constraint that is to be subjected to determination includes a logical constraint on an order relation between the plurality of elements.

7. An abductive reasoning method comprising:
(a) acquiring background knowledge information which represents background knowledge by at least one logical formula and query information which represents an observed fact by at least one logical formula;
(b) generating a plurality of hypotheses with reference to the background knowledge information and the query information;
(c) constructing a constraint set by listing some of a plurality of logical constraints to be satisfied between a plurality of elements constituting each of the plurality of hypotheses;
(d) retrieving any one of the plurality of hypotheses as a candidate solution hypothesis with reference to the constraint set;
(e) determining whether the candidate solution hypothesis satisfies a logical constraint which is among logical constraints to be satisfied between elements constituting the candidate solution hypothesis and which is not included in the constraint set; and
(f) outputting the candidate solution hypothesis as a solution hypothesis in a case where the candidate solution hypothesis satisfies the logical constraint which is not included in the constraint set,
(a) to (f) being carried out by an abductive reasoning apparatus.

8. A non-transitory computer-readable storage medium storing therein a program for causing a computer to function as an abductive reasoning apparatus,
the program causing the computer to carry out:
an acquisition process for acquiring background knowledge information which represents background knowledge by at least one logical formula and query information which represents an observed fact by at least one logical formula;
a generation process for generating a plurality of hypotheses with reference to the background knowledge information and the query information;
a construction process for constructing a constraint set by listing some of a plurality of logical constraints to be satisfied between a plurality of elements constituting each of the plurality of hypotheses;
a retrieval process for retrieving any one of the plurality of hypotheses as a candidate solution hypothesis with reference to the constraint set;
a determination process for determining whether the candidate solution hypothesis satisfies a logical constraint which is among logical constraints to be satisfied between elements constituting the candidate solution hypothesis and which is not included in the constraint set; and
an output process for outputting the candidate solution hypothesis as a solution hypothesis in a case where the candidate solution hypothesis satisfies the logical constraint which is not included in the constraint set.
